(19) United States
(12) Patent Application Publication
(10) Pub. No.: US 2025/0099329 A1
(43) Pub. Date: Mar. 27, 2025

(54) INFUSION BAG, AND METHOD FOR PRODUCING SAME

(71) Applicant: Fresenius Kabi Deutschland GmbH, Bad Homburg (DE)

(72) Inventor: Torsten BRANDENBURGER, Bad Homburg (DE)

(21) Appl. No.: 18/730,683

(22) PCT Filed: Feb. 3, 2023
(86) PCT No.: PCT/EP2023/052661

§ 371 Date: Jul. 19, 2024

(30) Foreign Application Priority Data
Feb. 4, 2022 (EP) 22155200.3

(51) Int. Cl. A61J 1/10

(52) U.S. Cl. CPC A61J 1/10

(57) ABSTRACT

An infusion bag can be filled with a medical liquid. The infusion bag includes a connector having at least one port and a head piece as a lower part, and a connection region as an upper part. A sealing element is clamped between the upper part and the lower part. The lower part has a welded portion via which the lower part is connected to at least a first chamber of the infusion bag. Between the welded portion and the upper part, the lower part has a flexible region that can be clamped to form a body having shoulders and a neck. Between the sealing element and the flexible region is a pierceable membrane.

### FIELD OF THE INVENTION

The invention relates to an infusion bag and a method for producing and filling the same. In particular, the invention relates to a multi-chamber bag with a parenteral nutrition composition.

### BACKGROUND OF THE INVENTION

An infusion bag is shown, for example, in the published patent application WO 2004/084793 A1. The infusion bag is made of two films welded together. The infusion bag comprises at least two connectors for removing and injecting liquid.

The connectors are each formed from a lower part that is welded into the infusion bag. The lower part is closed with an upper part, with a sealing element pressed in between the upper and lower parts.

When producing such an infusion bag, the lower parts can be used as ports to fill the infusion bag.

For parenteral nutrition, infusion bags with a plurality of chambers, for example three chambers, are in particular well known. The different compositions of a parenteral nutrition solution are arranged in the chambers.

Only immediately before using the infusion bag are the liquids from the chambers mixed together, for example by opening pull-open weld seams, so-called peel seams, between the chambers, for example by rolling the bag and pressing on the chamber.

To produce a sterile infusion bag, in particular one filled with a parenteral nutrition solution, it may be necessary to autoclave it after production. On the one hand, this is energy and time consuming and can in some cases also lead to a reduction in the quality of the food compositions or components contained in the infusion bag. It is therefore advantageous if the infusion bag can already be filled aseptically, in particular in an aseptic zone.

### OBJECT OF THE INVENTION

In contrast, the invention is based on the object of providing an infusion bag or a method for producing the same, in which the filling of the infusion bag and closing of the ports in an aseptic zone is improved.

### SUMMARY OF THE INVENTION

The object of the invention is already achieved by an infusion bag and by a method for producing an infusion bag according to one of the independent claims.

Preferred embodiments and further developments of the invention can be inferred from the subject matter of the dependent claims, the description and the drawings.

The invention relates to an infusion bag which is designed to be filled with a medical liquid, with the infusion bag comprising at least one port which is designed as a lower part of a connector and which comprises a head piece with a connection region for an upper part of the connector, with a sealing element being able to be clamped in between the upper part and the lower part, with the lower part comprising a weld-in section via which the lower part is connected to at least a first chamber of the infusion bag, with the lower part having a flexible, clampable region above the weld-in section and with the lower part, in particular between the sealing element and the flexible, clampable region, comprising a pierceable membrane which closes off access to the flexible, clampable region in the port. The pierceable membrane is arranged between the sealing element and the flexible, clampable region, in particular in an assembled state of the upper part on the lower part of the connector.

According to claim 1, the invention is described by an infusion bag which is designed to be filled with a medical liquid, with the infusion bag comprising at least one port which is designed as a lower part of a connector which comprises a head piece with a connection region for an upper part of the connector, with a sealing element being able to be clamped in between the upper part and the lower part, with the lower part comprising a weld-in section via which the lower part is connected to at least a first chamber of the infusion bag, with the lower part having a flexible, clampable region above the weld-in section, characterised in that the flexible, clampable region forms a body with shoulders and merges into the head piece via a neck, with the lower part comprising a pierceable membrane which closes off access to the flexible, clampable region in the port.

The invention is based on the finding that this empty bag can be sealed by a membrane in the lower part of the connector in such manner that the interior of the bag remains sterile when the bag is brought, for example, into an aseptic zone. The empty bags can be sterilised after production, for example by means of radiation, ETO gas, heat or another suitable method. When the empty bags are transported further, the interior of the bag, which is sealed by the membrane, remains sterile.

Only when the infusion bag is to be filled and is located in an aseptic zone, will the membrane be pierced, for example by means of a filling nozzle, and the bag is opened. After opening the membrane, the bag or at least one chamber of the bag is filled by means of the filling nozzle. The membrane is a membrane that can be pierced, in particular with a filling nozzle. It can be opened by piercing it.

Due to the flexible, clampable region between the weld-in section and the upper part, the bag can be closed after filling by clamping the lower part. Then, for example, in the next station, still within the aseptic zone, the upper part can be placed on the lower part to form a connector.

The membrane is preferably formed in one piece with the lower part. In particular, the lower part and the membrane are formed by a one-piece plastic injection-moulded part. As a result, access to the flexible, clampable region and thus also access to the interior of the bag is initially securely closed by the membrane. In another embodiment, the membrane can also be designed as an insert part. This is then preferably fixed in a clamped manner into the lower part.

According to a preferred embodiment, the membrane has a wall thickness of 0.05 to 1 mm, preferably 0.1 to 0.3 mm. Such a wall thickness provides a secure seal for access to the flexible, clampable region, but can be easily opened by piercing.

The infusion bag is in particular designed as a multi-chamber bag. In particular, it can comprise at least two or three chambers. At least one chamber, preferably all chambers, of the multi-chamber bag with the lower part are provided or equipped with the pierceable membrane.

The upper part can comprise a break-off cap. Such a break-off cap has a predetermined breaking point, for example in the form of a weakening line. Before using the connector, the break-off cap is removed and the sealing element is now exposed so that a spike or needle can be inserted to remove or add liquid, in particular an additive, for example an active ingredient. The sealing element is preferably designed to be self-sealing, i.e. it closes automatically after the spike or needle is pulled out.

The membrane is preferably arranged spaced apart from the sealing element in a connection region of or between the upper part and the lower part. This connection region can also be considered as the head of the lower part.

The connection region comprises at least one collar and/or a groove for latching the upper part onto or with the lower part. The membrane is therefore preferably located in an upper region of the lower part which is less flexible than the clampable region. Preferably, the membrane is arranged in the head piece of the lower part.

Preferably, the membrane is spaced apart from the opening of the lower part, in particular the membrane can be located in the lower half of the head of the lower part. This ensures that the filling nozzle is guided safely and there is no risk of the port kinking during filling. In particular, the membrane is arranged in a region 4 mm to 8 mm, preferably 5 mm to 7 mm, below the front surface of the head region.

Furthermore, the membrane can be located at the level of a circumferential groove, as is provided in one embodiment. This can have advantages for production with injection moulding, as the wall of the lower part is less thick in the region of the groove. The material saved in this way can at least partially form the membrane.

The invention further relates to the infusion bag filled with a medical liquid, with the membrane being pierced. Such an infusion bag has, instead of the closed membrane wall, a broken edge or remaining wall of the membrane.

Preferably, the upper part is placed on the lower part and latched with the lower part. The sealing element is clamped between the upper part and the lower part.

Furthermore, the present invention also comprises a port for an infusion bag or for the infusion bag described above, which is designed as a lower part of a connector, which comprises a head piece with a connection region for an upper part of the connector, with a sealing element being able to be clamped in between the upper part and the lower part, with the lower part comprising a weld-in section via which the lower part can be connected to at least a first chamber of the infusion bag, with the lower part having a flexible, clampable region above the weld-in section, characterised in that the flexible, clampable region forms a body with shoulders and merges into the head piece via a neck, with the lower part comprising a pierceable membrane which closes off access to the flexible, clampable region in the port.

Preferably, the membrane is arranged in the head piece of the lower part. This supports a defined opening of the membrane.

In one embodiment, the head piece comprises a collar followed by a groove, with another collar being adjoined for latching the upper part. Preferably, the membrane is located in the region of the, preferably circumferential, groove.

The medical liquid is a liquid which is used for medical purposes and is preferably administered intravenously. In a preferred embodiment, the medical liquid is an infusion solution. Possible examples of such infusion solutions include
sterile water;
saline solutions, in particular solutions containing NaCl, KCl, CaCl and/or Mg;
solutions containing carbohydrates, in particular glucose solutions;
solutions, emulsions and/or suspensions containing nutrients for parenteral nutrition, in particular lipids, amino acids and/or glucose;
colloid solutions, in particular for blood replacement therapy (e.g. Voluven®); and/or
so-called premixed systems in which an active ingredient, e.g. paracetamol, has already been added to the medical liquid.

The invention further relates to a method for filling an infusion bag with a medical liquid, comprising the steps:
providing an infusion bag with a sterilised interior closed with a membrane, with the infusion bag comprising at least one lower part of a connector with a weld-in section, via which it is connected to at least one chamber of the infusion bag, with the lower part having a clampable region;
providing a sterilised upper part with a sealing element;
sterilising the outer surface of the lower part, at least in the region of the membrane, in particular by means of steam;
piercing the membrane, in particular by means of a filling nozzle, and filling the at least one chamber with the medical liquid by means of the filling nozzle;
placing the upper part, in particular together with the sealing element, on the lower part;
clamping the lower part at least after the step of filling the at least one chamber.

The infusion bag is preferably sterilised, in particular by means of radiation, before filling, in particular before being placed in the aseptic zone.

In particular, an infusion bag with a plurality of chambers is used.

In a further development of the invention, the filling nozzle is placed in a sealing manner on the lower part.

In particular, a filling nozzle can be used here, which comprises a filling tube with which the membrane is pierced.

A casing tube can extend around the filling tube and sits in a sealing manner on the lower part, in particular on the head of the lower part.

Furthermore, the filling nozzle can comprise an annular channel extending around the filling tube through which steam can be released for sterilisation purposes.

In particular, a filling nozzle can be used in which the filling tube protrudes from the annular channel and extends into the lower part during filling. The annular channel is thereby formed by an intermediate space between the filling tube and a casing tube. In particular, the casing tube lies in a sealing manner against the head of the lower part when filling the infusion bag.

After filling, the lower part is closed with the upper part. This takes place in an aseptic zone.

The now finished, i.e. filled and sealed, infusion bag can then be packaged in a secondary bag.

The invention further relates to the use of the method described above for producing an infusion bag, in particular a multi-chamber bag.

The invention further relates to an infusion bag that can be produced or is produced using the method.

### BRIEF DESCRIPTION OF THE DRAWINGS

The subject matter of the invention will be explained in more detail below with reference to the drawings FIG. 1 to FIG. 13.

FIG. 1 shows a multi-chamber bag arranged in a secondary package.

FIG. 2 and FIG. 3 are views of the connector, which serves as a removal port.

FIG. 4 is a sectional view along the line A-A of FIG. 3.

FIG. 5 and FIG. 6 are views of the connector, which serves as an injection port.

FIG. 7 is a sectional view along the line A-A of FIG. 6.

FIG. 8 to FIG. 10 show schematically the steps for filling the infusion bag.

FIG. 11 is a longitudinal section of the lower part, which is intended for the removal port, during filling with a filling nozzle.

FIG. 12 is a corresponding longitudinal section of the lower part, which is used for the injection port.

FIG. 13 is a flow chart of the steps for producing an infusion bag.

### DETAILED DESCRIPTION OF THE DRAWINGS

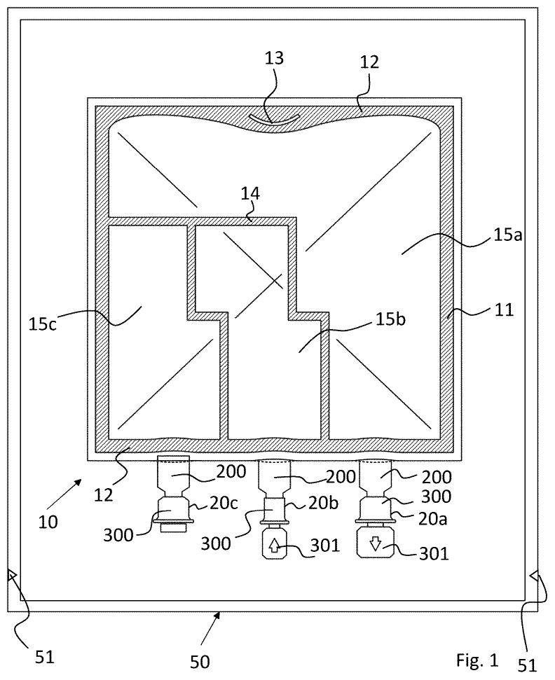

FIG. 1 shows an infusion bag 10, which in this exemplary embodiment is designed as a three-chamber bag. The chambers 15a-15c are separated from each other by pull-open or tear-open weld seams 14. The different components of a parenteral nutrition composition are located in the chambers 15a-15c. For example, a first chamber is filled with a lipid emulsion, a second chamber with an amino acid solution and/or a third chamber with a glucose solution or electrolyte solution. Before using the infusion bag 10, the chambers 15a-15c are connected to one another by separating the pull-open weld seams 14, for example by rolling and pressing the infusion bag 10.

The infusion bag 10, which is made of two films, is closed by longitudinal weld seams 11 and transverse weld seams 12. The infusion bag 10 comprises a hanger 13 for hanging on a rack.

The connectors 20a and 20b as well as the blind cap 20c are welded into a transverse weld seam 12. The blind cap 20c and the connectors 20a, 20b each comprise a lower part 200, which serves as a port for filling one of the chambers 15a-15c. The lower parts/ports 200 are each closed with an upper part 300.

The connector 20a serves as a removal port and is closed with an upper part 300, which comprises a break-off cap 301. Removal generally takes place by inserting a spike which is connected to a transfer system.

The connector 20b serves as an injection port and also comprises an upper part 300 with a break-off cap 301. The injection, for example of an active ingredient, can be carried out in particular by means of a needle syringe.

The blind cap 20c is closed with a cap 300. The blind cap 20c serves only to fill the chamber 15c, but not to add or remove liquid.

The infusion bag 10 is sterile, including its outside, and is located in a secondary package 50. The secondary package 50 is formed here from two films welded together. The secondary package 50 is designed as a tear-open package. For this purpose, at least one notch 51 can be present in one of the weld seams.

Preferably, as represented, two notches 51 are introduced.

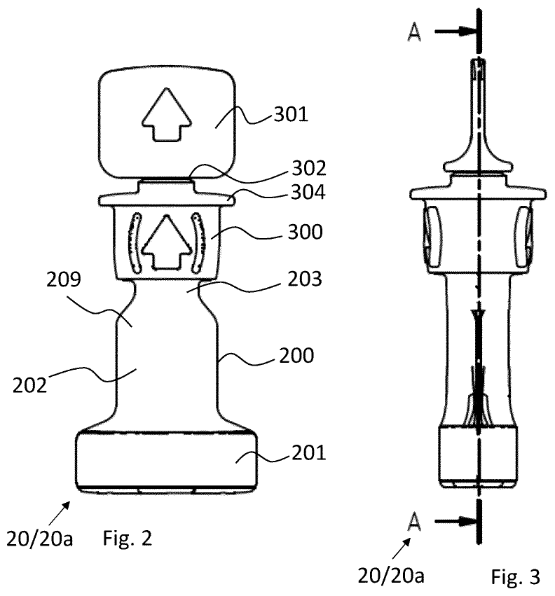

FIG. 2 is an external view of a connector 20, in this case the connector 20a, which serves as a removal connector. The connector 20/20a is formed by a lower part 200 and an upper part 300.

The lower part 200 comprises a weld-in section 201 for welding into the outer seam 11 of the infusion bag 10. As represented in comparison with the side view according to FIG. 3, the weld-in section 201 can have an elongated, in particular boat-shaped, shape.

The weld-in section 201 merges into a flexible, clampable region 202. During filling, the clampable region 202 can take on a valve function. After filling the infusion bag 10, the clampable region 202 can be pressed closed by means of a clamp and the infusion bag 10 can be moved to the next station at which the opened port 200 is closed, in particular by pressing the upper part 300 onto the lower part 200.

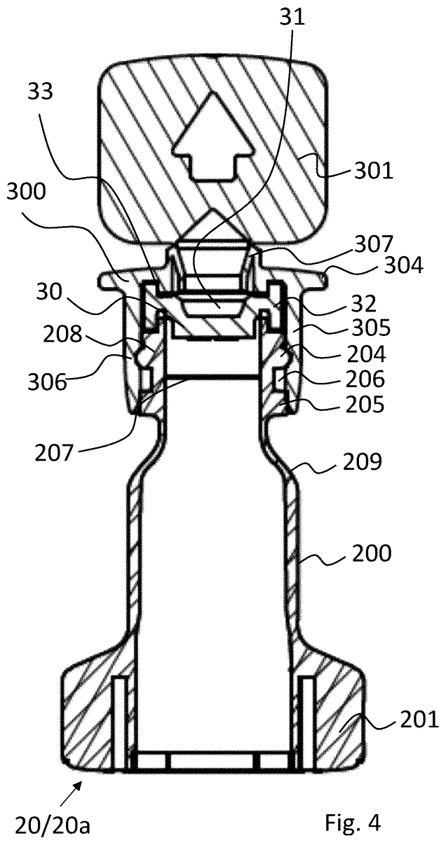

The lower part can also be clamped by clamping the bag around the region of the foot section of the port. The clampable region 202 forms a body which, via a neck 203, merges into a head region or head 208 (see FIG. 4), which serves as a connection region for the upper portion 300. In detail, the clampable region 202 forms a body with shoulders 209, to which the neck 203 is adjoined at the top (see also FIG. 3). This design serves in particular to improve the clamping behaviour. The clampable region 202 can also be used to clamp a transfer system during infusion.

The upper part 300 comprises a collar 304 at which the connector 20/20a can be gripped. The upper part 300 further comprises a break-off cap 301, which is connected to the remaining upper part 300 via a predetermined breaking point 302.

FIG. 4 is a longitudinal section along the line A-A of FIG. 3. The head piece 208, which serves to connect to the upper part 300, comprises a collar 205 at the bottom, which is followed by a groove 206. Another collar 204 is then adjoined. In this exemplary embodiment, the collar 204 is rounded.

The collar 204 is used to latch onto the upper part 300. A groove 306 of the upper part 300, which is designed to be complementary to the collar 204, latches onto the collar 204. Only the wall of the upper part 300 rests on the lower collar 205. A sealing element 30 is pressed in between the upper part 300 and the lower part 200. The sealing element 30 rests on the front side of the head 208. In this exemplary embodiment, the sealing element 30 comprises a ring 32 surrounding it, which is held in a form-fitting manner between the upper part 300 and the lower part 200. Due to the circumferential ring 32, which is connected to the rest of the sealing element 30 via a radially extending circumferential web 33, the sealing element 30 is not pushed out even under greater forces, such as those that occur when piercing with a spike.

The sealing element 30 comprises a depression 31 on the upper side, which in particular facilitates centring during piercing.

Furthermore, the upper part 300 comprises a conically shaped insertion region 307, which also facilitates the insertion of a spike. The conical insertion region 307 projects beyond the collar 304 of the upper part 300.

The membrane 207, which closes the empty bag, is located adjacent to the groove 206. Thus, during injection moulding of the lower part 200, material displaced through the groove 206 can form the membrane 207.

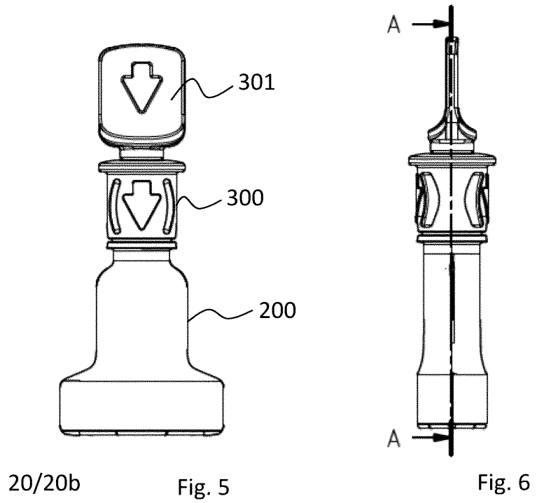

FIG. 5 is a corresponding plan view and FIG. 6 a side view of the connector 20/20b, which serves as an injection port.

This connector 20b is also formed from a lower part 200 and an upper part 300, with the upper part having a break-off cap.

The connector 20b has a smaller diameter. This is used to insert a syringe, preferably the cannula of a needle syringe.

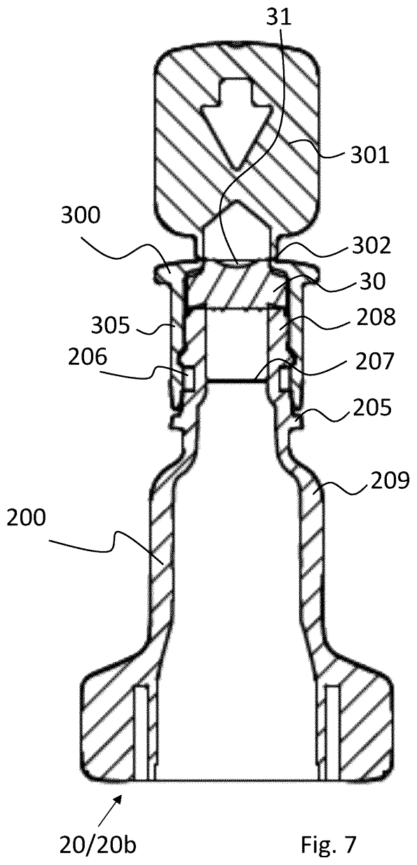

FIG. 7 is a longitudinal section along the line A-A of FIG. 6.

The connector 20b is largely designed in the same way as the connector 20a. Here too, the membrane 207 is located at the level of a groove 206.

In contrast to the connector represented in FIG. 4, the wall of the upper part 300 does not surround the collar 205. The collar 205 serves as a stop for the upper part 300.

The sealing element 30 rests on the front side of the head 208 of the lower part 200.

In contrast to the connector represented in FIG. 4, the sealing element 30 does not comprise a circumferential ring. The sealing element 30 is merely pressed between the lower part 200 and the upper part 300. When piercing with a needle, the forces generally do not exceed those when a spike is used.

The predetermined breaking point 302 runs flush with the adjacent sealing element 30. After breaking off the break-off cap 301, the sealing element 30 is easily accessible. The sealing element 30 can comprise a depression 31 which facilitates piercing with a syringe.

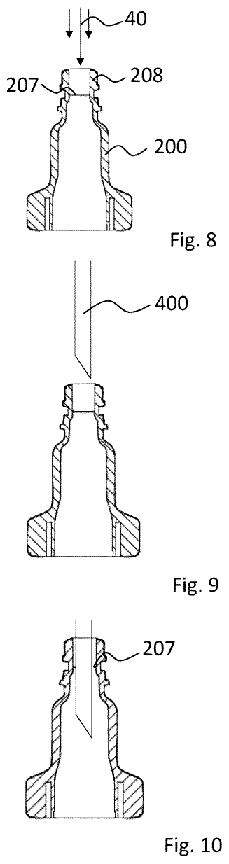

FIG. 8 to FIG. 10 show schematically the filling of the infusion bag 10.

As represented in FIG. 8, the head region or the head 208 of the lower part 200 is first sterilised by steam 40. The steam 40 in particular strikes the outer side of the membrane 207.

Then, as represented in FIG. 9 and FIG. 10, the membrane 207 is pierced by means of a filling nozzle 400 and the infusion bag 10 is filled. A circumferential remainder of the membrane 207 remains.

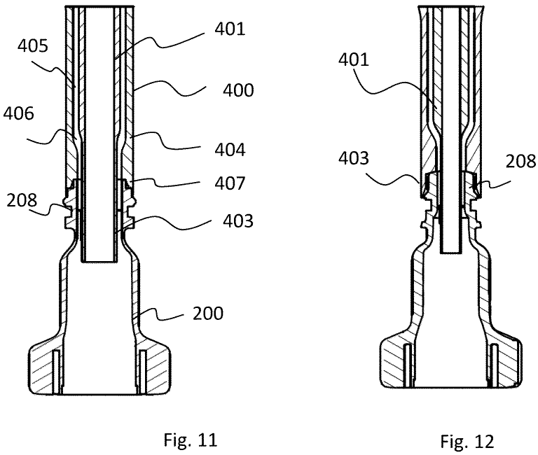

FIG. 11 shows in a longitudinal section how the lower part 200 of the connector 20a, serving as a removal port, is connected to the filling nozzle 400 during filling.

The filling nozzle 400 comprises a filling tube 401, which extends through the head 208 of the lower part during filling. The membrane 207 has been pierced with the filling tube 401.

The filling tube 401 is arranged in a casing tube 404. An annular channel 405 is formed between the filling tube 401 and the casing tube 404.

During filling, the casing tube 404 sits in a sealing manner on the front surface of the head 208. For this purpose, the casing tube 404 in this exemplary embodiment has a collar 407 on the front side, which is adapted to the shape of the front side of the head 208.

Sterilisation can be carried out using steam 40 via the annular channel 405.

At a step 406, the outer diameter of the filling tube 401 decreases in the direction of the opening of the filling tube 401.

At the same time, the inner diameter of the casing tube 404 decreases such that its wall thickness increases. In this way, a particularly robust design can be achieved.

As represented in FIG. 12, the filling nozzle 400 for the injection port is designed accordingly except for the dimensions.

The filling tube 401 has a smaller diameter than the filling nozzle according to FIG. 11 and the collar 403 of the casing tube 404 is adapted to the different shape of the head 208.

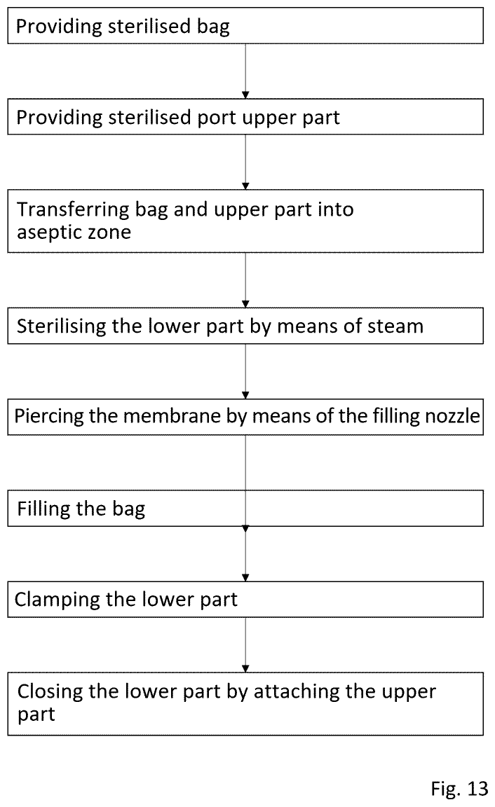

FIG. 13 shows a flow chart of the steps for producing an infusion bag according to an embodiment of the method according to the invention.

First, a sterilised infusion bag 10 and a sterilised upper part 300 are provided.

The infusion bag 10 and the upper part 300 are transferred to the aseptic zone.

The lower part 200, in particular the head 208 of the lower part 200 including the membrane 207, is then sterilised by means of steam 40.

The membrane 207 is then pierced by means of the filling nozzle 400, in particular by means of the filling tube 401.

The infusion bag 10 is then filled. The lower part 200 is then clamped, in particular directly or indirectly, and the filled infusion bag 10 is transferred to the next station, where the lower part 200 is closed by attaching the upper part 300.

The infusion bag 10 can then be packaged in a secondary bag 50, for example while still in the aseptic zone, with the secondary bag 50 preferably being impermeable to oxygen.

The invention made it possible to improve the aseptic filling of an infusion bag 10.

### LIST OF REFERENCE NUMERALS

10 Infusion bag
11 Longitudinal weld seam
12 Transverse weld seam
13 Hanger
14 Pull-open weld seam
15a-15c Chamber
20,20a-20b Connector
20c Blind Cap
30 Sealing element
31 Depression
32 Ring
33 Web
40 Steam
50 Secondary bag
51 Notch
200 Lower part/Port
201 Weld-in section
202 Clampable region
203 Neck
204 Collar
205 Collar
206 Groove
207 Membrane
208 Head or head piece
209 Shoulder
300 Upper part
301 Break-off cap
302 Predetermined breaking point
304 Collar
305 Base part
306 Groove
307 Insertion region
400 Filing nozzle
401 Filing tube
403 Piercing section
404 Casing tube
405 Annular channel
406 Step
407 Collar

1. An infusion bag configured to be filled with a medical liquid, the infusion bag comprising a connector, the connector comprising:
at least one port having a head piece as a lower part and a connection region as an upper part; and
a sealing element configured to be clamped between the upper part and the lower part, wherein:
the lower part has a weld-in section via which the lower part is connected to at least one first chamber of the infusion bag,
the lower part has a flexible, clampable region above the weld-in section,
the flexible, clampable region comprises a body with shoulders and a neck, the neck merging into the head piece, and
the lower part comprises a pierceable membrane configured to close access to the flexible, clampable region.

2. The infusion bag of claim 1, wherein the pierceable membrane is in the head piece.

3. The infusion bag of claim 1, wherein:
the pierceable membrane is formed with the lower part as one piece, or
the pierceable membrane is an insert part clamped to the lower part.

4. The infusion bag of claim 1, wherein the pierceable membrane has a wall thickness of from 0.05 to 1 mm.

5. The infusion bag of claim 1, wherein the infusion bag defines a plurality of chambers including the at least one first chamber connected to the lower part.

6. The infusion bag of claim 1, wherein, after the pierceable membrane is pierced, the infusion bag is configured to be filled with the medical liquid.

7. The infusion bag of claim 1, wherein the upper part and the sealing element close the lower part.

8. The infusion bag of claim 1, wherein the infusion bag is packaged in a secondary package.

9. The infusion bag of claim 1, wherein the upper part comprises a break-off cap.

10. The infusion bag of claim 1, wherein the pierceable membrane is spaced from the sealing element.

11. The infusion bag of claim 1, wherein the upper part is latched to the lower part, and the sealing element is clamped between the upper part and the lower part.

12. A connector for an infusion bag, the connector comprising:
a port having a head piece as a lower part and a connection region as an upper part; and
a sealing element configured to be clamped between the upper part and the lower part, wherein:
the lower part has a weld-in section via which the lower part is connected to at least one first chamber of the infusion bag,
the lower part has a flexible, clampable region above the weld-in section,
the flexible, clampable region comprises a body with shoulders and a neck, the neck merging into the head piece, and
the lower part comprises a pierceable membrane configured to close access to the flexible, clampable region.

13. The port of claim 12, wherein the pierceable membrane is in the head piece.

14. The port of claim 12, wherein the head piece comprises a collar, a groove adjacent the collar, and another collar adjacent the groove, the other collar configured to latch onto the upper part.

15. The port of claim 14, wherein the pierceable membrane is in the groove.

16. A method for filling an infusion bag with a medical liquid, the method comprising:
providing the infusion bag with a sterilised interior closed with a membrane, wherein the infusion bag comprises a connector having at least one lower part having a weld-in section via which the lower part is connected to at least one chamber of the infusion bag, and wherein the lower part also has a clampable region;
providing a sterilised upper part comprising a sealing element;
sterilising an outer surface of the membrane;
piercing the membrane;
filling the at least one chamber with the medical liquid using a filling nozzle;
placing the upper part with the sealing element on the lower part; and
clamping the clampable region of the lower part after filling the at least one chamber with the medical liquid.

17. The method of claim 16, further comprising sterilizing the interior of the infusion bag before filling the at least one chamber with the medical liquid.

18. The method of claim 16, wherein the infusion bag defines a plurality of chambers, and wherein filling the at least one chamber with the medical liquid comprises filling the plurality of chambers with the medical liquid via the lower part.

19-20. (canceled)

21. The method of claim 16, wherein the filling nozzle comprises a filling tube and an annular channel formed between the filling tube and a casing tube, the filling tube protrudes from the annular channel and extends into the lower part during filling of the at least one chamber with the medical liquid, and the casing tube seals against a head of the lower part during filling of the at least one chamber with the medical liquid.

22. The method of claim 16, further comprising packaging the infusion bag in a secondary package.

23-24. (canceled)
